(19) United States
(12) Patent Application Publication
(10) Pub. No.: US 2018/0165431 A1
(43) Pub. Date: Jun. 14, 2018

(54) METHOD, APPARATUS AND SYSTEM FOR DEVICE REPLACEMENT DETECTION AND DEVICE RECOMMENDATION

(71) Applicant: THOMSON Licensing, Issy-les-Moulineaux (FR)

(72) Inventors: Christoph NEUMANN, Rennes (FR); Jean-Ronan VIGOUROUX, Rennes (FR); Pascal LE GUYADEC, SAINT CLOUD (FR); Jaideep CHANDRASHEKAR, San Francisco, CA (US)

(21) Appl. No.: 15/578,686

(22) PCT Filed: May 24, 2016
(86) PCT No.: PCT/EP2016/061673

§ 371 Date: Nov. 30, 2017

(30) Foreign Application Priority Data
Jun. 1, 2015 (EP) 15305839.1
Oct. 22, 2015 (EP) 15306695.6

(51) Int. Cl. G06F 21/31; G06F 21/44; G06Q 30/02; H04L 29/06

(52) U.S. Cl. CPC G06F 21/316; H04L 63/0876; G06Q 30/02; G06F 21/44

(57) ABSTRACT

A method for detecting device replacement in a network is proposed. A salient idea is to monitor the connectivity of a plurality of devices connected to a home gateway over time, to compute a set of fingerprints at least associated with a device over time, wherein a fingerprint is representative of a usage by one user or a group of user over time. In case a new device is detected connected to the home gateway, a fingerprint associated with this new device for a current period of time is compared with the fingerprints associated with other devices over a previous period of time. In case there is a fingerprint match between the fingerprint associated with the new device and a fingerprint associated with a device that did not connect to the gateway since the new device appeared, a device replacement is detected between those devices.

### 1. TECHNICAL FIELD

The technical field of the disclosed method, device and system is related to data mining, user profiling, recommendation and knowledge discovery.

### 2. BACKGROUND ART

Internet service providers generally look for added value services to be delivered to their customers in order to differentiate from their competitors. They deliver internet access to customers by providing and operating an access point such as an Internet gateway device in the customer's home. The Internet gateway device, in addition to provide Internet access in the home, also generally provides basic home networking features such as Ethernet switching and/or WiFi access. A customer can therefore connect to the Internet at home from a variety of devices, such as personal computers, tablets, smartphones, set-top-boxes, smart TVs, etc . . .

Internet service providers have a limited knowledge of their customers, and generally rely on customer services, agencies or dedicated commercial surveys to learn about their customer habits and needs so as to propose or even design new services. It would be desirable for Internet service providers to extract knowledge from their network data so as to better understand their customer habits and needs. It would be desirable for Internet service providers to have a more direct way to gather knowledge on how a customer uses his devices in the home network and when the customer plans to replace a device, for recommendation purposes.

More precisely, service providers generally use customer enquiries in order to know which devices are used by their customers in their networks. Service providers may also be aware of the devices being replaced by their customers when those devices are directly purchased from them. However a service provider has no practical mean to know that a device has been replaced by another device when the new device is acquired from a third party different from the service provider itself. Some new methods are needed to detect a device replacement in a network, without limiting a customer in the choice of a new device introduced in his network.

### 3. SUMMARY

A salient idea is to monitor the connectivity of a plurality of devices connected to a home gateway over time, to compute a set of fingerprints at least associated with a device over time, wherein a fingerprint is representative of a usage by one user or a group of user over time. In case a new device is detected connected to the home gateway, a fingerprint associated with this new device for a current period of time is compared with the fingerprints associated with other devices over a previous period of time. In case there is a fingerprint match between the fingerprint associated with the new device and a fingerprint associated with a device that did not connect to the gateway since the new device appeared, a device replacement is detected between those devices.

To that end a method for detecting a replacement of a first device by a second device in a network from an operating status of a gateway sampled by the gateway over at least one time window is disclosed. The device replacement detection is responsive to:
a connectivity to the gateway of the first device over a previous and a current time windows;
a connectivity to the gateway of the second device over the previous and the current time windows;
a matching of a first fingerprint at least associated with the first device over the previous time window, to a second fingerprint at least associated with the second device over the current time window;
   wherein the first device and second device connectivity, the first and second fingerprints are obtained from the gateway operating status.

According to a preferred embodiment the previous and current time windows are consecutive and non-overlapping.

According to a particularly advantageous variant, the connectivity to the gateway of the first device is set to true over the previous time window, and set to false over the current time window. The connectivity to the gateway of the second device is set to false over the previous time window, and set to true over the current time window.

According to another variant, the gateway operating status comprises a plurality of connection status of the first device to the gateway over a sample time interval.

According to another variant, the connection status of the first device over the sample time interval is set to true in case at least one MAC address of the first device is present in an address resolution table of the gateway over the sample time interval, else set to false.

According to another variant, the connection status of the first device over the sample time interval corresponds to the status of a physical interface of the gateway, associated with the first device over the sample time interval.

According to another variant, the connectivity to the gateway of the first device over the time window is obtained from a ratio of the connection status samples of the first device set to true in the time window, over the number of samples of the time window.

According to another variant, the first and second fingerprints comprise a set of values of a plurality of parameters representative of a behavior of the first and second devices over a given elementary duration.

According to another variant, the plurality of parameters comprises at least one parameter among:
a connection status;
an amount of generated network traffic;
an amount of received network traffic;
   wherein the at least one parameter is determined from the gateway operating status for the first and second devices over the given elementary duration.

According to another variant, obtaining the first and second fingerprints over the respectively associated previous and current time window, further comprises aggregating the set of values of the plurality of parameters, over the duration of the time window, wherein the duration is equally split in time periods of the elementary duration.

According to another variant, aggregating comprises applying one operation among:
mean;
max;
sum;
   wherein the operation is applied over the time window modulo an integer.

According to another variant, the device replacement detection method is implemented in a gateway.

According to another variant, the device replacement detection method is implemented in a device among:
a server;
a personal computer
a cloud computing instance;
   wherein the device receives a plurality of data reports from at least one gateway, wherein a data report comprises a plurality a values representative of the operating status of the gateway over time.

In a second aspect a device for detecting a replacement of a first device by a second device in a network from an operating status of a gateway sampled by the gateway over at least one time window is also disclosed. The device comprises a processor configured to:
obtain a connectivity to the gateway of the first device from the gateway operating status over a previous and a current time windows;
obtain a connectivity to the gateway of the second device from the gateway operating status over the previous and the current time windows;
obtain a first fingerprint at least associated with the first device from the gateway operating status over the previous time window;
obtain a second fingerprint at least associated with the second device from the gateway operating status over the current time window;
detect the device replacement being responsive to the first device and second device connectivity, and to a matching of the first fingerprint to the second fingerprint.

According to a variant, the device is a gateway. According to another variant, the device is a server receiving a plurality of data reports from at least one gateway, wherein a data report comprises a plurality a values representative of the operating status of the gateway over time.

In a third aspect a computer program for detecting a replacement of a first device by a second device in a network from an operating status of a gateway sampled by the gateway over at least one time window is also disclosed. The computer program comprises program code instructions executable by a processor for:
obtaining a connectivity to the gateway of the first device from the gateway operating status over a previous and a current time windows;
obtaining a connectivity to the gateway of the second device from the gateway operating status over the previous and the current time windows;
obtaining a first fingerprint at least associated with the first device from the gateway operating status over the previous time window;
obtaining a second fingerprint at least associated with the second device from the gateway operating status over the current time window;
detecting the device replacement being responsive to the first device and second device connectivity, and to a matching of the first fingerprint to the second fingerprint.

In a fourth aspect a computer program product for detecting a replacement of a first device by a second device in a network from an operating status of a gateway sampled by the gateway over at least one time window is also disclosed. The computer program product is stored on a non-transitory computer readable medium, and comprises program code instructions executable by a processor for:
obtaining a connectivity to the gateway of the first device from the gateway operating status over a previous and a current time windows;
obtaining a connectivity to the gateway of the second device from the gateway operating status over the previous and the current time windows;
obtaining a first fingerprint at least associated with the first device from the gateway operating status over the previous time window;
obtaining a second fingerprint at least associated with the second device from the gateway operating status over the current time window;
detecting the device replacement being responsive to the first device and second device connectivity, and to a matching of the first fingerprint to the second fingerprint.

While not explicitly described, the present embodiments may be employed in any combination or sub-combination. For example, the present principles are not limited to the described variants, and any arrangement of variants and embodiments can be used. Moreover the present principles are not limited to the described sampling of the gateway operating status. The present principles are not further limited to the described monitoring reports characteristics, usage profile aggregation, computation and comparison examples. Besides, any characteristic, variant or embodiment described for the method is compatible with a device intended to process the disclosed method and with a computer-readable storage medium storing program instructions.

### 4. BRIEF DESCRIPTION OF THE DRAWINGS

In the drawings, an embodiment of the present disclosure is illustrated. It shows:

FIG. 1 illustrates the method for detecting a device replacement according to a particular embodiment;

FIG. 2 illustrates a processing device for detecting a device replacement according to a preferred embodiment;

FIG. 3 represents an exemplary architecture of the processing device of FIG. 1 according to a particular embodiment.

### 5. DESCRIPTION OF EMBODIMENTS

Internet access at home is generally delivered through an Access Point, e.g. an Internet gateway device or home gateway, which is generally operated by an Internet service provider. The home gateway device generally also provides local home networking capabilities via Ethernet, USB, WiFi, or even 3G/4G Femto. The term “Internet gateway”, “home gateway” or simply “gateway” will be used interchangeably throughout the description.

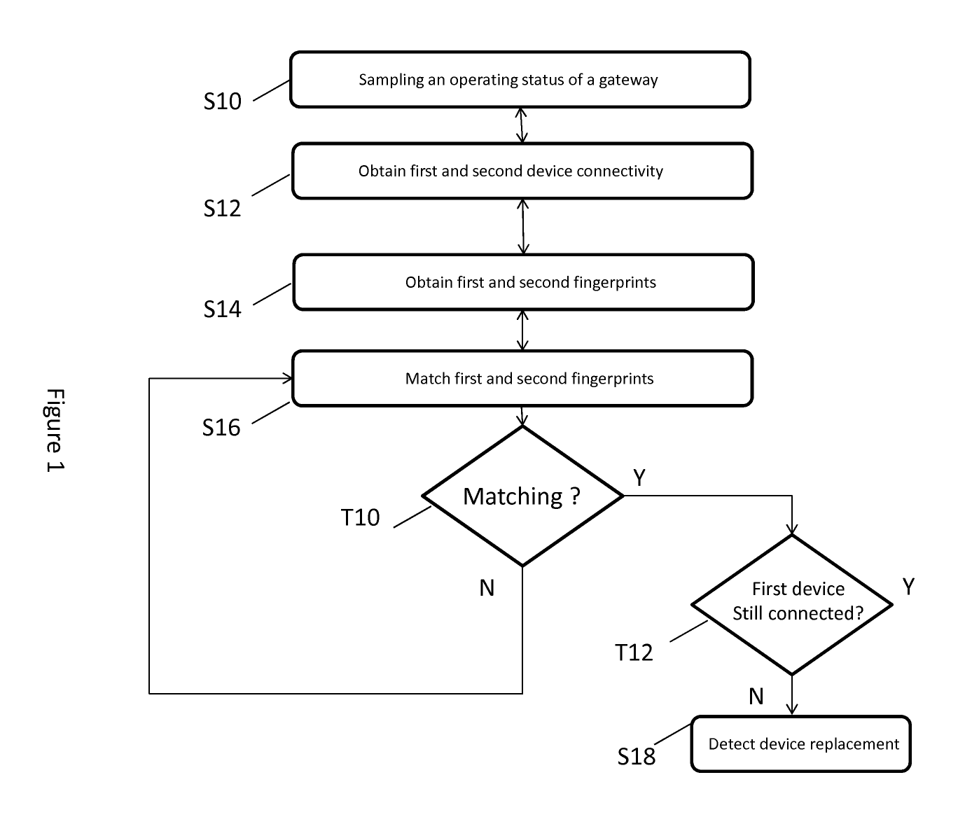

FIG. 1 illustrates the method for detecting a device replacement of a first device by a second device in a network from an operating status of a gateway, sampled by the gateway over at least one time window. The replacement detection method is responsive to a connectivity of the first device to the gateway over a previous and a current time window, wherein the first device connectivity is obtained from the sampled gateway operating status. The replacement detection method is further responsive to a connectivity of the second device to the gateway over a previous and a current time window, wherein the second device connectivity is obtained from the sampled gateway operating status. The replacement detection method is further responsive to a matching of a first fingerprint at least associated with the first device over the previous time window, to a second fingerprint at least associated with the second device over the current time window, wherein the first and second fingerprints are also obtained from the sampled gateway operating status.

Internet service providers usually deploy a network monitoring infrastructure so as to detect failures either in the access network or in any of the home gateway devices. Being able to detect and to recover from a failure is key to their business as it is strongly related to customer satisfaction.

A monitoring infrastructure according to an embodiment of the present principles comprises for instance a home gateway capable of regular reporting values of a plurality of parameters that are representative of its operating state at a given time. The periodicity of these reports can be adjusted by the Internet service provider. The monitoring infrastructure also comprises at least one server collecting the reports from the home gateways, also referred to hereinafter as data collector. Advantageously, the data collector also performs some data processing of the received reports and stores them. Storage is done as raw data storage (i.e. storing the reports as received, i.e. as raw monitoring reports), and/or as pre-processed data.

In the step S10, the operating status of the gateway is sampled by the gateway, resulting a plurality of samples also called plurality of raw monitoring reports. A raw monitoring report according to an embodiment of the present principles typically comprises a time value, indicating at which time the report is generated by the gateway, and a plurality of data values representing the operating status of the gateway at that time. A collection of monitoring raw reports with consecutive time values for a gateway can be seen as a sampling of the operating status of the gateway over time.

A home gateway according an embodiment of the present principles has a capability of logging which device in the home network has been active at a certain time. The term “active” is to be understood as connected to the home network and sending/receiving data. The active status monitoring of devices connected to the home network provided by the home gateway is done by extracting information from various network communication protocols and/or network interfaces. For instance, when a device connects to the home network, it starts a home network connection, and consequently requests a network address (e.g. an Internet Protocol address or IP address), for instance via DHCP (Dynamic Host Configuration Protocol). A DHCP server is typically comprised in the gateway. In the network address request, the connecting device communicates its MAC (Media Access Control) address to the gateway. The gateway also maintains ARP (Address Resolution Protocol) tables for performing the address resolution between MAC addresses and IP addresses for data transmission purposes. The gateway uses a timer for cleaning the ARP tables (in other words it deletes an entry of the ARP table when a corresponding device has been inactive for a given duration).

According to an embodiment of the present principles, the presence of a MAC address in an ARP table of the gateway is used to determine whether the device being identified by that MAC address is currently active or not.

According to a variant embodiment of the present principles, status monitoring of active/inactive state is realized through monitoring the physical status of the LAN (Local Area Network) physical layer, where the LAN comprises for example wired Ethernet and/or wireless WiFi and/or wireless Bluetooth. This allows for example monitoring the active/inactive status of a device that is directly connected to an Ethernet connector of the gateway. More generally any method for monitoring the active/inactive status of a device connected to the home gateway is compatible with the present principles.

According to an embodiment of the present principles, a home gateway logs a volume of data traffic going through it via different logical interfaces and over time. The home gateway measures and logs the amount of data traffic (e.g. as a total number of bytes and/or as a total number of packets) over a given time period, for instance during 30 seconds. The time period corresponds to the monitoring report periodicity. A logical interface corresponds to a measurement point characterized by a dedicated location in the gateway architecture and protocol stack. A data flow is typically going through a logical interface and can be measured. Logical interfaces where data volume is measured/logged may be of different types, as for instance physical interfaces corresponding to the physical connectors of the gateway, or layer 2 interfaces, corresponding for example to VLANs (Virtual LAN) or the whole home network interface, or the whole WAN (Wide Area Network) interface.

According to a particular embodiment of the present principles, data flows going through the gateway are classified according to a type of service such as video, voice (VoIP, for Voice over IP) or best effort, and the home gateway logs the volume of classified data flows. Advantageously, the home gateway monitors the data traffic volume generated and/or received by an individual device connected to the home network, for improved information granularity.

In a preferred embodiment, a monitoring report that represents data traffic volume comprises:
a time value representing the time at which the report was generated;
a list of device identifiers, for instance a list of MAC addresses of the devices connected to the home network as logged by the home gateway for instance in its ARP tables, and for each of the devices, identified by its MAC address:
   an active/inactive status value (for instance 1 for “active”, and 0 for “inactive”), also called connection status for the corresponding device, reflecting whether the device is considered as active or inactive at that time
   the amount of data traffic generated by that device over the time period (i.e. since a last report)
   the amount of data traffic received by that device over the time period (i.e. since a last report)
      In other words, the sampled gateway operating status comprises a plurality of gateway operating status samples, wherein a sample comprises a plurality of device connection status representing which devices are connected to the gateway over the corresponding sample time interval.
      Any variant for representing the data traffic volume in reports is compatible with the present principles.

In yet another variant, monitoring the amount of data traffic generated or received by a device is used to determine the connection status of that device. In case the device generates or receives a non-null amount of data traffic over a consecutive set of time periods, its connection status is set to active or true. Symmetrically in case the device does not generate or receive any data traffic over a consecutive set of time periods, its connection status is set to inactive or false.

In the step S12, a connectivity to the gateway of the first device and a connectivity to the gateway of the second device are obtained over a previous and a current time window. The connectivity to the gateway of a device over a time window is set to true in case the device is considered as connected to the gateway over the time window. For example the connectivity of a device over a time window is obtained from a ratio of the connection status samples of the device set to true in the time window over the number of samples of the time window, wherein connection status samples are determined according to any previously described embodiment. Advantageously, the previous and current time windows are consecutive time windows, and have the same duration. Monitoring the gateway operating status of a set of consecutive time windows of a same duration is a practical approach as it simplifies interpretations of the monitored results. Alternatively, using times windows of varying sizes is also compatible with the disclosed principles.

According to a preferred embodiment, in the step S14 a first fingerprint, associated with the first device is obtained over the previous time window, and a second fingerprint at least associated with the second device is obtained over the current time window. Obtaining a fingerprint at least associated with a device, also called a usage profile for a device is described hereafter. According to a specific embodiment of the present principles, at least one data collector in the WAN (e.g. a data collector of an Internet service provider) collects monitoring reports from one or more gateway and computes, based on the collected reports, at least one usage profile for a device that has been detected as being connected to a gateway. A usage profile for a device, (also called fingerprint associated with a device), reflecting the usage of the device over time, is determined based on the measurement of values of a single parameter or can be a vector comprising values of a plurality of different parameters, where one determined value represents an aggregation of parameter values of a given type, and for a given elementary duration, and wherein a given duration is equally split in time periods of the same elementary duration. For example, considering the parameter type is the active/inactive status of a device connected to the home network, and a time interval is one hour, and the usage profile duration is one day, a day is equally split in twenty four time periods, the usage profile is a vector of twenty four values, where each value represents whether the device was active or inactive during the corresponding time period, i.e. hour of the day. If a device is detected as active only for a portion of the time period, different variants are possible among which a float value representing the portion of the time period the device was active; Boolean values representing the active/inactive status which are set to 1 or 0 depending whether the device was most of the time active or inactive during the time period. The following day, the measured active/inactive status during a time period, in any of its variants is aggregated with the value of the same time period of the day before. Various aggregation methods are possible (sum, mean, max, min . . . ). In a first variant the aggregation is done from the first connection of the device to the home network, but in another variant, the aggregation is performed on an aggregation window, for instance one week. Other variants are possible according to variant embodiments of the present principles, for instance a profile duration of one week, a time interval of 1 hour, and an aggregation window of four weeks, resulting in a vector of 168 values. In addition to the active/inactive state value, the data traffic generated and/or received during a time interval is comprised in the usage profile, resulting in a more complex vector.

According to an embodiment of the present principles, for each home, the data collector maintains a history of device usage profiles. The data collector stores the device usage profiles in the history for a limited amount of time. Advantageously this amount of time is determined individually for a device, e.g. using the time of the last connection of the device. For instance, the data collector maintains the device usage profile one month after the last connection of the device; if a device did not connect to the home over a period longer than a month, its usage profile is removed from the history.

According to an embodiment of the present principles, when a new device connects to the home network and is detected by a home gateway, because for instance a MAC address is being detected on the home network of the gateway for the first time, a new usage profile computation is started. After an acquisition process of the usage profile of that new device, the usage profile of the new device is compared to the usage profiles of other home devices of the same home gateway. An existing technique is used for performing profile matching evaluation/comparison (signature comparison, Euclidean distance computation and comparison, . . . ). When the usage profile of a new device matches with or is similar to the usage profile of an existing device, based on usage profile history, a “device replacement” event is generated which indicates to the Internet service provider that one of its customers has replaced one of his/her devices. Indeed the usage profile per device that is acquired by the data collector reflects the typical behavior of a single user or a group of users making use of a particular device. There are cases where a single device, such as a set top box, is operated by different users alternatively within a single customer home. The usage profile can be seen as a kind of fingerprint for a typical home usage. Being able to retrieve a same fingerprint related to another home device in the same home while the fingerprint of another device has changed or while another device with a similar fingerprint has been inactive during a while is a very strong indicator that the customer replaced the old device by a new device. Since it may require some time to build a usage profile (e.g. several weeks), the device replacement event may be triggered some time (e.g. several weeks) after the new device first connected to the network.

According to a preferred embodiment, fingerprints associated with devices are obtained over time windows. The first fingerprint, associated with the first device over the previous time window is matched in the step S16 with the second fingerprint at least associated with the second device obtained over the current time window. Fingerprint matching is done as previously described for usage profile matching. In a test T10, the matching between the first and the second fingerprints is evaluated according to existing techniques, such as for example a signature comparison, Euclidean distances computation and comparison. In a test T12, the first device connectivity is evaluated over the current time window. In case the first and the second fingerprints match, and in case the first device connectivity over the current time window is set to false, meaning that the first device is disconnected over the current time window, a device replacement of the first device by the second device, is detected in the step S18. Advantageously, the device replacement of the first device by the second device is detected in case the connectivity to the gateway of the second device is set to true over the current time window and to false over a given number of contiguous time windows prior and contiguous to the current time window, representing for example a period of one or two month. Testing the disconnection of the second device over a large period of time, is advantageous as it better indicates the second device is a new device that did not connect to the gateway in the past. Alternatively, In case the first and the second fingerprints match, and in case the first device connectivity over the current time window is set to true, meaning that the first device is still connected over the current time window, the first and the second matching fingerprints are considered as a unique fingerprint associated to both the first device and the second device. More generally, a single fingerprint may be associated to more than one device. Fingerprints are for example first obtained on a device basis. Then in a second step the matching between fingerprints is evaluated according to above mentioned techniques. Matching fingerprints associated to multiple different devices represent a single fingerprint associated to multiple different devices.

According to a variant embodiment of the present principles, a device replacement event is generated in case a usage profile of a new device matches with or is similar to a usage profile of second device that is not new to the network, based on stored history data, and if in addition the second device does not connect to the home network within a time window that is close to the new device appearance. E.g. a usage profile of a new mobile phone device connected to the home network is close to that of a second device based on the usage profile history. For instance, a device replacement event is only triggered if the second device with a similar or same usage profile has disappeared from the home network since several days (e.g. 10 days) before or after the new device first connected to the home network.

According to a variant embodiment of the present principles, the usage profile is computed in the home gateway, and computed usage profiles are reported to a data collector in the WAN, e.g. to a server in the network of an Internet service provider.

According to yet another variant embodiment of the present principles, the usage profile and the home history are computed in the home gateway. The processing of the various usage profiles and the device replacement events are realized in the home gateway as well. Device replacement events are sent to a data collector in the WAN, e.g. to a server in the network of an Internet service provider.

According to a variant embodiment of the present principles, usage profiles are computed per device, and if for a home gateway, a same usage profile is detected for different devices over time, a directed elementary graph is built for a gateway per usage profile as follows: if a same or similar usage profile (i) was initially detected for a device A, then for a device B, then for a device C, a directed elementary graph is built for the usage profile (i), where graph nodes represent devices (A, B, C) and graph edges represent the transitions that have been detected between devices for that usage profile (for instance A->B->C). According to a further variant of the present principles, edges are weighted using the device age at replacement time or a value that is calculated using the device age at replacement time. The device age represents the time elapsed since the first connection of that device to the home network.

According to a further variant embodiment of the present principles, from the data collector perspective, a global graph is built from all the elementary graphs, determined for all the usage profiles for all the home gateways. In that global graph, nodes represent device classes or families of devices (like Apple Iphone 5 or Samsung Galaxy S4), and edges between two device classes represent whether a replacement from one device by the other has been detected by the system. According to a particular embodiment or the present principles, edges can be weighted by the amount of transitions that have been detected between those device classes.

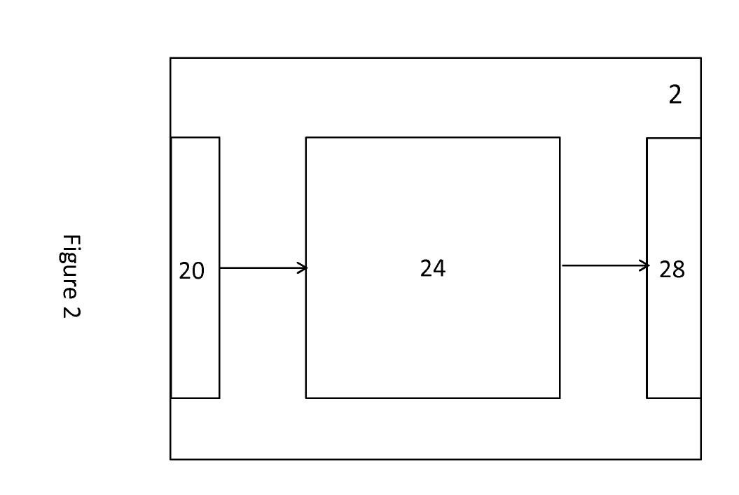

FIG. 2 depicts a processing device 2 for detecting a replacement of a first device by a second device in a network from an operating status of a gateway sampled by the gateway over at least one time window.

According to a specific and non-limiting embodiment, the processing device 2 comprises an input 20 configured to receive at least one operating status of a gateway, sampled by the gateway. The at least one operating status of a gateway is received from a network interface. According to different embodiments of the principle, the network interface belongs to a set comprising
A local area network interface such as for example Ethernet, WiFi, MoCA or a power line interface, wherein the local network interface provides a connection to a broadband delivery network via a home gateway;
A broadband network interface, comprising a wide area network interface such as xDSL, GPON, WiMAX.
   More generally any network interface allowing to receive at least one gateway operating status sample, is compatible with this principle.

According to a specific and non-limiting embodiment, the sampling of the operating status is internal to the device 2, and the input 20 is part of an internal interface within the device 2 such as for example a location in the memory, where samples of the gateway operating status are available.

The input 20 is linked to a processing module 24 configured to detect a replacement of a first device by a second device in a network from an operating status of a gateway sampled by the gateway over at least one time window.

The processing module 24 is configured to obtain a connectivity to the gateway of the first device from the sampled gateway operating status over a previous and a current time windows,. The processing module 24 is further configured to obtain a connectivity to the gateway of the second device from the sampled gateway operating status over the previous and the current time windows. The processing module 24 is further configured to obtain a first fingerprint at least associated with the first device from the sampled gateway operating status over the previous time window and a second fingerprint at least associated with the second device from the sampled gateway operating status over the current time window. The processing module 24 is further configured detect the device replacement of the first device by the second device being responsive to the obtained first device and the second device connectivity, the matching of the first fingerprint to the second fingerprint. An information item representing the detection of the replacement of a first device by a second device in a network is sent to an output 28 such as for example a display means or a network interface. According to a particular embodiment, the network interface belongs to the set described for the input 20. According to a particular embodiment, the display means is external to the device and the output 28 sends the information item to an external display means. According to different embodiments of the principle, the display means, internal or external, belongs to a set comprising:
a personal computer screen;
a TV screen;
a tablet;
a smartphone screen.
   More generally any display means allowing to display a detection of a device replacement, and any network interface allowing to send a detection of a device replacement, are compatible with this principle.
   In a specific embodiment, the processing device 2 is an Internet gateway device, and the device replacement detection within the home network is performed in the Internet gateway of that home network. In another embodiment, the processing device 2 is an Internet server, collecting data from a plurality of Internet gateways and detecting device replacements within the home networks of the plurality of gateways.

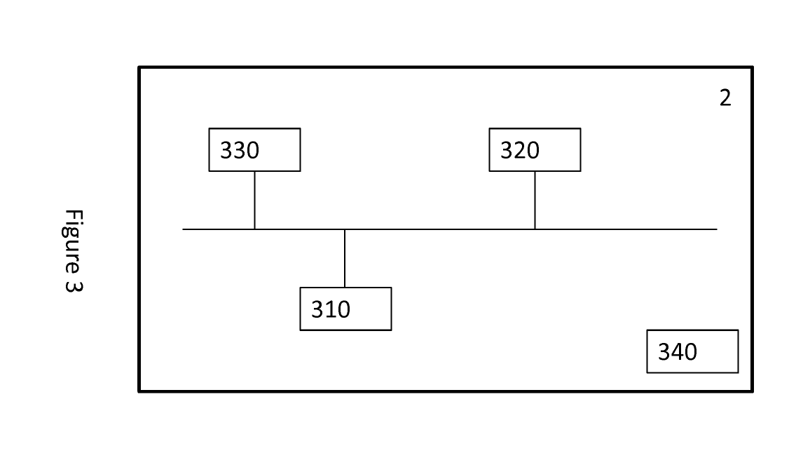

FIG. 3 represents an exemplary architecture of the processing device 2 according to a specific and non-limiting embodiment, where the processing device 2 is configured to detect a replacement of a first device by a second device in a network from an operating status of a gateway sampled by the gateway over at least one time window. The processing device 2 comprises one or more processor(s) 310, which is(are), for example, a CPU, a GPU and/or a DSP (English acronym of Digital Signal Processor), along with internal memory 320 (e.g. RAM, ROM, EPROM). The processing device 2 comprises one or several Input/Output interface(s) 330 adapted to send to display output information and/or to allow a user to enter commands and/or data (e.g. a keyboard, a mouse, a touchpad, a webcam, a display), and/or to send/receive data over a network interface; and a power source 340 which may be external to the processing device 2.

According to an exemplary and non-limiting embodiment, the processing device 2 further comprises a computer program stored in the memory 320. The computer program comprises instructions which, when executed by the processing device 2, in particular by the processor 310, make the processing device 2 carry out the processing method described with reference to FIG. 1. According to a variant, the computer program is stored externally to the processing device 2 on a non-transitory digital data support, e.g. on an external storage medium such as a SD Card, HDD, CD-ROM, DVD, a read-only and/or DVD drive and/or a DVD Read/Write drive, all known in the art. The processing device 2 thus comprises an interface to read the computer program. Further, the processing device 2 could access one or more Universal Serial Bus (USB)-type storage devices (e.g., “memory sticks.”) through corresponding USB ports (not shown).

According to exemplary and non-limiting embodiments, the processing device 2 is a device, which belongs to a set comprising:
an Internet gateway device;
a set top box device;
a digital media player device;
a TV device;
a mobile device ;
a communication device ;
a game device ;
a tablet (or tablet computer) ;
a smartphone;
a laptop;
a web server;
a cloud computing instance.

Naturally, the present principles are not limited to the embodiments and characteristics previously described. In particular, the principles are compatible with any type of network interface and display means. They are further compatible with any mean of sampling the operating status of the gateway, including for example the sampling time period, and the content of the samples themselves. The disclosed principles are not limited to the described monitoring reports characteristics, the usage profile aggregation, computation and comparison examples.

1. A method for detecting a replacement of a first device by a second device in a network from an operating status of a gateway sampled by said gateway over at least one time window, said replacement detection being responsive to:
a matching of a first fingerprint at least associated with said first device over a previous time window, to a second fingerprint at least associated with said second device over a current time window, said first fingerprint associated with said first device changing from the previous time window to current time window;
wherein said first and second fingerprints are obtained from said gateway operating status.

2. The method according to claim 1, wherein said previous and current time windows are consecutive and non-overlapping.

3. The method according to claim 1, wherein said replacement detection is further responsive to:
said first device being connected to said gateway over said previous time window and disconnected from said gateway over said current time window;
said second device being disconnected from said gateway over said previous time window and connected to said gateway over said current time window.

4. The method according to claim 1, wherein said gateway operating status comprises a plurality of connection status of said first device to said gateway over a sample interval.

5. The method according to claim 4, wherein said connection status of said first device over said sample interval is set to true in case at least one MAC address of said first device is present in an address resolution table of said gateway over said sample interval, else set to false.

6. The method according to claim 4, wherein said connection status of said first device over said sample interval corresponds to the status of a physical interface of said gateway, associated with said first device over said sample interval.

7. The method according to claim 5, wherein whether said first device is connected to or disconnected from the gateway over said time window is obtained from a ratio of the connection status samples of said first device set to true in said time window, over the number of samples of said time window.

8. The method according to claim 1, wherein said first and second fingerprints comprise a set of values of a plurality of parameters representative of a behavior of said first and second devices over a given elementary duration.

9. The method according to claim 8, wherein said plurality of parameters comprises at least one parameter among:
a connection status;
an amount of generated network traffic;
an amount of received network traffic;
wherein said at least one parameter is determined from said gateway operating status for said first and second devices over said given elementary duration.

10. The method according to claim 8, wherein said obtaining said first and second fingerprints over said respectively associated previous and current time window, further comprises aggregating said set of values of said plurality of parameters, over the duration of said time window, and wherein said duration is equally split in time periods of said elementary duration.

11. The method according to claim 1, wherein said method is implemented in said gateway.

12. The method according to claim 1, wherein said method is implemented in a server, receiving a plurality of data reports from at least one gateway, wherein a data report comprises a plurality a values representative of the operating status of said gateway over time.

13. A device for detecting a replacement of a first device by a second device in a network from an operating status of a gateway sampled by said gateway over at least one time window, said device comprising a processor configured to:
detect a replacement of a first device by a second device in a network from an operating status of a gateway sampled by said gateway over at least one time window, said device replacement being responsive to a matching of a first fingerprint of said gateway operating status over a previous time window to a second fingerprint of said gateway operating status over a current time window, said first fingerprint being associated with said first device and changing from the previous time window to current time window, said second fingerprint being associated with said second device.

14. The device according to claim 13, wherein said device is a gateway.

15. The device according to claim 13, wherein said device is server receiving a plurality of data reports from at least one gateway, wherein a data report comprises a plurality a values representative of the operating status of said gateway over time.

16. The device according to claim 13, wherein said previous and current time windows are consecutive and non-overlapping.

17. The device according to claim 13, wherein said replacement detection is further responsive to:
said first device being connected to said gateway over said previous time window and disconnected from said gateway over said current time window;
said second device being disconnected from said gateway over said previous time window and connected to said gateway over said current time window.

18. A non-transitory computer readable medium storing program code instructions executable by a processor for performing the method according to claim 1.
